(19) United States
(12) Patent Application Publication
(10) Pub. No.: US 2011/0197256 A1
(43) Pub. Date: Aug. 11, 2011

(54) METHODS FOR SECURING A PROCESSING SYSTEM AND DEVICES THEREOF

(75) Inventors: Joseph James Sharkey, Deerfield, NY (US); Rian Patrick Quinn, Utica, NY (US)

(73) Assignee: ASSURED INFORMATION SECURITY, INC., Rome, NY (US)

(21) Appl. No.: 12/973,548

(22) Filed: Dec. 20, 2010

Related U.S. Application Data
(60) Provisional application No. 61/287,819, filed on Dec. 18, 2009.

(51) Int. Cl. G06F 21/00

(52) U.S. Cl. 726/1; 726/22

(57) ABSTRACT

A method, computer readable medium, and apparatus for securing a processing system includes implementing a virtual machine manager (VMM) using a hardware assisted handler in secure processing apparatus. One or more critical events are monitored with the VMM in the secure processing apparatus. One or more behaviors in response to the one or more monitored critical events are controlled with VMM.

This application claims the benefit of U.S. Provisional Patent Application Ser. No. 61/287,819, filed Dec. 18, 2009, which is hereby incorporated by reference in its entirety.

### FIELD

This invention relates to methods for securing a processing system and devices thereof.

### BACKGROUND

Several new security vulnerabilities have arisen at the architectural level due to the introduction of multi-core technology. Such vulnerabilities introduce opportunities for an attacker to open covert side channels for communication, perform a Denial-of-Service (DoS) against the system, or even steal a cryptographic key. Simply generating patches in the OS to known vulnerabilities is not sufficient to provide resilience to attack for sensitive information systems. Instead, a more robust solution is needed to provide a trusted and secure platform for processing the nation's most sensitive information. Such solutions can be approached from either the hardware or software level. Hardware-based approaches can certainly provide a significantly higher level of security than software-based counterparts. However, hardware-based defenses require fundamental changes to components such as motherboards, chipsets, and processors and, as such, require a significant amount of time before they can be readily available for use in the mainstream market. Furthermore, they cannot fix vulnerabilities in existing systems.

There are several features of modern computer architectures, such as x86-based systems, that provide for hardware assisted enforcement of security policies. These features include a hierarchical privilege level mechanism via rings, various processor modes of execution, and Virtual Machine Extensions (VMX). Each of these architectural features is briefly outlined below.

Privilege Mitigation via Rings: Modern x86-based processors provide security based on privilege levels known as rings. Ring 0 is the most privileged and is typically used by the OS for the kernel and drivers, while ring 3 is the least privileged and is used by user-mode applications. The hardware provides functionality to enforce the security of ring structures, ensuring that certain operations are only performed in ring 0. While this hardware design affords opportunities to protect the systems from attacks originating in ring 3, it is unable to defend against ring 0 attacks. Since modern OSs require that the kernel and drivers all operate in ring 0, it is difficult to mitigate ring 0 access. With the abundance of zero-day attacks that provide ring 0 privilege, it must be assumed that a dedicated attacker with sufficient time and resources will be able to obtain ring 0 access to the system. Therefore, the protections afforded by ring levels alone are not sufficient to defend systems against advanced attackers.

Modes of Execution: x86-based processors have several basic modes of operation. Each mode has special uses and characteristics that distinguish it from the other modes. Real Mode is a 16-bit mode typically used for system boot-strap code, including the BIOS/EFI and firmware. With the advent of 32-bit computing and advanced concepts such as paging and multithreaded execution, Protected Mode was introduced. This is the mode most commonly used today by modern OSs such as Windows and Linux. It provides security that is based on privilege levels known as rings (as described above).

Another mode of operation supported by modern x86-based processors is known as System Management Mode (SMM). This mode was introduced to allow BIOS/EFI to handle hardware-specific events in a way that is transparent to all other software running on the system including ring 0. For example, SMM is often used to adjust fan speeds in the event of a thermal emergency (i.e. when the system is getting too hot) to prevent permanent damage to the hardware. The adjustment of fan speeds tends to be manufacturer specific. To prevent manufacturers from having to design, test, and support separate software for multiple OSs, SMM allows these manufacturers to write a single piece of software to handle these system events.

To support the transparency of SMM, motherboards are equipped with System Management Random Access Memory (SMRAM); and a locking mechanism that prevents access to SMRAM from outside of SMM.

Virtualization: Virtualization allows for the decoupling of hardware from the OS, providing the opportunity for the Virtual Machine Manager (VMM) to regulate and control access to specific hardware components and features of the architecture. To facilitate virtual machine technology, modern x86 ISAs encompass a set of Virtual Machine Extensions (VMX). Specifically, VMX provides the ability to trap on predefined events, including but not limited to interrupts, port I/O, and MSR access. A VMM can be installed via software to handle the occurrence of these events. In a sense, the VMM runs at a higher privilege level than the OS in ring 0 since it sits between the OS and the hardware. This positioning allows the VMM to monitor and filter access from the OS to the hardware. The architecture grants full privileges only to the VMM and protects it from modification or interference by the OS. As such, the use of VMX technology to trap on and handle particular events in the system can be a useful tool for monitoring and mitigating malicious software running in ring 0.

In an attempt to abstract SMM as well as provide additional securities to protect SMM, x86 based systems include another mode of execution called Dual Monitor Mode (DMM). DMM allows for a second VMM to execute in SMM thus allowing the SMM handler to execute in a virtualized environment. Intel is currently working on defining a means to implement DMM as well as the protocol for handling the transfer from protected mode to SMM called the SMM Transfer Monitor (STM).

Memory Protection: The x86 architecture provides several mechanisms for enforcing memory protection, including segmentation and paging. These mechanisms allow for separation of address space between ring 0 and ring 3 applications. The hardware enforces privilege checking before allowing access to memory from the CPU. The shortfall of this design is that memory access not originating in the CPU cannot be mitigated. For example, Direct Memory Access (DMA) is used to provide specific hardware components the ability to directly write to memory without requiring the CPU. This is very useful for enhanced performance of devices such as Network Interface Cards (NICs) and Graphic Cards. However, it exposes security vulnerabilities because it allows the CPU memory protections to be circumvented.

Although the x86 platform supports many advanced features, including many designed especially for security, x86 based systems have been shown to have many implementation and architectural based flaws that can be exploited to gain access to Ring 0 and even SMM. The rest of this section is dedicated to describing a few examples of such malicious software.

Q35 TOLUD Modification: x86 based systems use the Top of Low Usable DRAM (TOLUD) register to configure the amount of RAM addressable from the 32-bit address space. This allows some physical addresses in the 32-bit range to be reserved for memory mapped I/O. If a system is equipped with 4 GB of DRAM, not all 4 GB may be used, as 32 bit physical addressing is limited to 4 GB and some of this is reserved for MMIO. For 64-bit addressing, modern chipsets provide mechanisms for memory remapping to allow the system to reclaim the wasted DRAM in addresses above the 32-bit boundary.

An exploit for the Q35 chipset has been shown that uses this memory remapping to gain access to System Management RAM (SMRAM). SMRAM refers to the physical address space where the System Management Mode Handler is located. SMRAM is locked by the BIOS/EFI to prevent access by non-SMM software. By using memory remapping, the Q35 chipset can be programmed to extend a portion of the physical address space to point to the location in DRAM for which the SMM Handler is located. It was shown that this allows unauthorized access to SMRAM.

Cache Attacks: A multi-level memory hierarchy is employed in x86 systems. The highest level of memory is the register file, where as the lowest level of memory is the hard-disk. Between these opposite extremes exists various levels of RAM, including caches and Main Memory. Cache typically resides on the CPU and is much faster than main memory which resides on the motherboard. Cache is used to buffer data from main memory for use by the CPU in an effort to reduce the latency of data and instruction operations.

Cache organization is dictated by various parameters, including cache size, access speed, and replacement policy. For example, the L2 cache in an Intel Core 2 Duo may be 6 Mb. This cache property, however, is static and cannot be changed without purchasing a different CPU. Some cache properties however, are configurable and can be programmed by software running on the CPU via Model Specific Registers (MSRs). These policies include whether or not memory writes to various addresses are cached or are sent straight to memory.

The default cache properties of SMRAM are set by BIOS to be write-through, meaning that all writes to SMRAM are passed directly through to main memory. If SMRAM is locked by the chipset, writes to these memory locations are ignored by the chipset. If, however, the SMRAM region of the cache is marked as write-back, the writes access the CPU cache and are only sent on to memory when the cache-line is evicted. In this case, the chipset still blocks writes to SMRAM, however reads are now coming from cache and not main memory. It was shown that an attacker can gain access to SMM by having their code write to SMRAM with the cache policy of SMRAM set to write-back. When a System Management Interrupt (SMI) occurs, the CPU will fetch the instructions from cache and not from main memory (which now contains the attacker's code and not the true SMM handler). Once an attacker is executing in SMM, SMRAM is unlocked, and the attacker has unfettered control of the system.

EFI/UEFI: The Extensible Firmware Interface (EFI) or Unified Extensible Firmware Interface (UEFI) refers to a replacement for the Basic Input/Output System (BIOS). The main problem with BIOS is that the implementation is manufacturer specific and therefore non-trivial to extend. The Extensible Firmware Interface aims to modernize the already existing form of BIOS and, at the same time, add extensibility that provides hardware manufacturers with the ability to extend the functionality of the EFI subsystems. The ultimate goal of EFI is to allow hardware manufacturers the ability to convert their OS kernel level drivers into EFI drivers, thus giving hardware manufacturers a cross-platform, cross-architecture means for supporting their devices.

The problem with EFI is that it was not designed with security in mind. EFI, like an operating system, runs in protected mode with ring 0 privileges. Since EFI and EFI applications/drivers execute unfettered, the system may become compromised if an attacker gains control of EFI, or at minimum finds a method to install an EFI application/driver. Furthermore, EFI and EFI applications/drivers execute with higher privileges than the operating system (since the operating system must communicate with EFI to access hardware).

John Heasman presented the ability to subvert EFI and SMM using the EFI specification at the Blackhat 2007 conference. The EFI specification, in its effort to remain extensible, also extends the ability to load EFI drivers into SMM. It's worth noting that the EFI specification describes the process needed for any EFI driver to gain access to SMM in an EFI environment.

To address this problem, Intel and the Unified EFI forum have begun work with the Trusted Computing Group to secure EFI. Although their efforts to secure EFI are promising, UEFI is still not being widely used and UEFI relies on a static root of trust. If for some reason any part of this chain is broken, EFI will be rendered unsecure. To combat these problems, as well as other problems with SMM, Intel is working towards a new implementation which utilizes a DMM called the SMM Transfer Monitor (as described above).

Traditional defensive software executes with the same privileges as the operating system. That is, the highest level of privileges the x86 platform provides the operating system and defensive software is ring 0. If an attacker gains access to ring 0, the operating system and defensive software may no longer be trusted, as the architecture itself may have been compromised. In order to address advanced malicious software methods, this security model may not be sufficient.

Intel has recognized that the existing x86 security model is limited and that changes are needed to provide a safer computing environment. To address these limitations and provide for a more robust and secure platform, Intel recently introduced Trusted Execution Technology (TXT). Formerly code named LaGrande, TXT augments the CPU and chipset with hardware that allows for the establishment of a dynamic root of trust. Effectively, TXT enforces new architectural restrictions that allow software to request an environment that is guaranteed to be trusted. Unfortunately, the addition of these features requires a significant redesign of the chipset and, as such, is only available on TXT-supported motherboards with TXT-supported BIOS versions.

These TXT technologies, however, are limited in that they rely on fundamental changes to system hardware. This makes it impossible to integrate these solutions into existing systems without replacing all of the hardware. More limiting, however, is the fact that these technologies may not be easily extended to address new or emerging threats because it is likely infeasible to modify the hardware on a fielded system. Since TXT is hardware based, if vulnerabilities in the implementation of TXT are found, an update would require new hardware. Many researchers have already found such problems one of which is Joanna Rutkowska who discovered that TXT does not measure System Management Mode. This vulnerability allows an attacker to circumvent TXT altogether.

### SUMMARY

A method for securing a processing system includes implementing a virtual machine manager (VMM) using a hardware assisted handler in secure processing apparatus. One or more critical events are monitored with the VMM in the secure processing apparatus. One or more behaviors in response to the one or more monitored critical events are controlled with VMM.

A non-transitory computer readable medium having stored thereon instructions for methods for securing a processing system comprising machine executable code which when executed by at least one processor, causes the processor to perform steps including implementing a virtual machine manager (VMM) using a hardware assisted handler. One or more critical events are monitored with the VMM. One or more behaviors in response to the one or more monitored critical events are controlled with the VMM.

A secure processing apparatus includes one or more processors with a hardware assisted handler operable to directly control the one or more processors and a virtual machine manager (VMM) implemented using the hardware assisted handler and a memory coupled to the one or more processors which are configured to execute programmed instructions stored in the memory including implementing a virtual machine manager (VMM) using a hardware assisted handler. One or more critical events are monitored with the VMM. One or more behaviors in response to the one or more monitored critical events are controlled with the VMM.

Accordingly, as illustrated and described herein this technology provides more effective methods and devices for securing a processing system. With this technology, unauthorized access and control to a processing system is prevented. Additionally, with this technology the processing system is not being susceptible to current modes of attack and can easily be updated for effectiveness against newly developing malware and intrusion threats. Further, with this technology existing motherboards and/or processors do not need to be replaced.

### BRIEF DESCRIPTION OF THE DRAWINGS

FIG. 1 is a block diagram of an environment with an exemplary secure processing apparatus; and

FIG. 2 is a flow chart of a method for securing a processing system.

### DETAILED DESCRIPTION

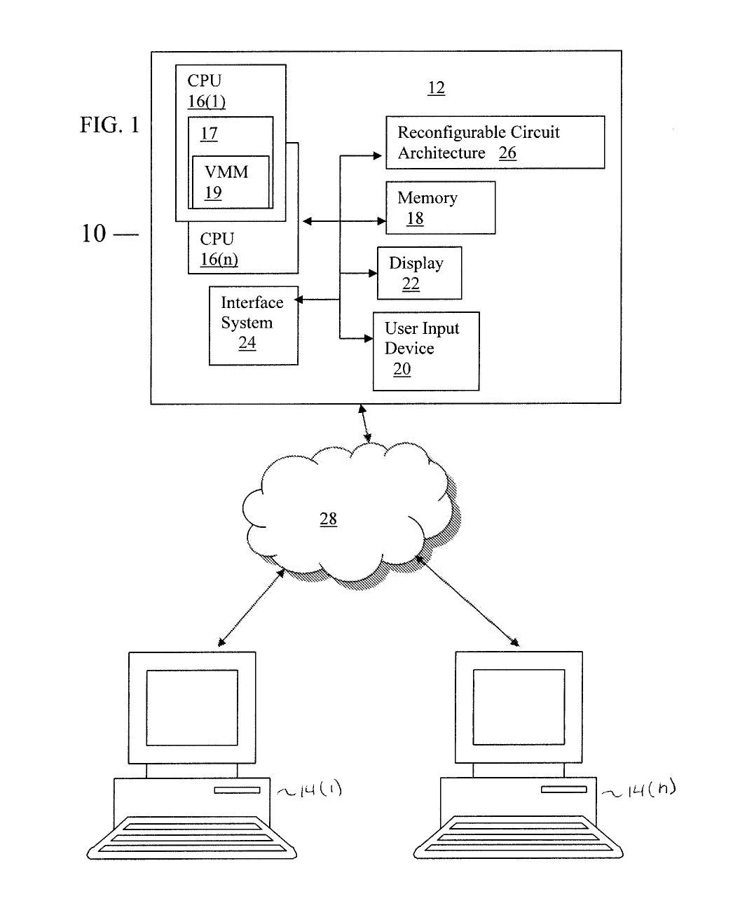

An environment 10 with an exemplary securing processing apparatus 12 is illustrated in FIG. 1. This environment 10 includes a secure processing apparatus 12 and in this example for illustration purposes a plurality of attacker computing devices 14(1)-14(n) coupled together by one or more communication networks 28, although this system can include other numbers and types of systems, devices, components, and elements in other configurations. The present invention provides a number of advantages including providing more effective methods and apparatuses for performing actions to secure a processing system.

The secure processing apparatus 12 includes central processing units (CPU) or processing cores 16(1)-16(n), a memory 18, a user input device 20, a display 22, an interface system 24, and an optional reconfigurable circuit architecture 26 which are coupled together by one or more buses or other links, although other numbers and types of systems, devices, components, and elements in other configurations and locations can be used. The processing cores 16(1)-16(n) in the secure processing apparatus 12 execute a program of stored instructions for one or more aspects of the present invention as described and illustrated by way of the exemplary embodiments herein, although other numbers and types of processors could be used. In this example, the processor 16(1) includes a hardware handler 17 configured to implement a virtual machine manager (VMM) 19, although the processing cores 16(1)-16(n) each could have other types and numbers of elements and configurations. The VMM 19 may be configured to monitor for one or more critical events in the secure processing apparatus 12 and to control one or more behaviors in the secure processing apparatus 12 in response to the one or more critical events as discussed in greater detail herein.

The memory 18 in the secure processing apparatus 12 stores these programmed instructions for one or more aspects of the present invention as described and illustrated herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to processor 16 can be used for the memory in the secure processing apparatus 12.

The user input device 20 in the secure processing apparatus 12 is used to input requests, selections, and other data, although the user input device could provide other functions and interact with other elements. The user input device can include keypads, touch screens, and/or vocal input processing systems, although other types and numbers of user input devices can be used.

The display 22 in the secure processing apparatus 12 is used to show data and information to the user, such as a requested application or other data by way of example only. The display in the secure processing apparatus 12 is a computer screen display, although other types and numbers of displays could be used depending on the particular type of mobile device.

The interface system 24 in the secure processing apparatus 12 is used to operatively couple and communicate between the secure processing apparatus 12 and the attacker computing devices 14(1)-14(n) via one or more of the communications networks 28, although other types and numbers of communication networks or systems with other types and numbers of connections and configurations can be used. By way of example only, the one or more of the communications networks 28 can use TCP/IP over Ethernet and industry-standard protocols, including NFS, CIFS, SOAP, XML, LDAP, and SNMP, although other types and numbers of communication networks, such as a direct connection, a local area network, a wide area network, modems and phone lines, e-mail, and wireless communication technology, each having their own communications protocols, can be used.

The optional reconfigurable circuit architecture 26 in the secure processing apparatus 12 comprises a field programmable gate array (FPGA), although other types and numbers of circuit architectures could be used. The reconfigurable circuit architecture 26 can be configured to act as the memory in the secure processing apparatus 12 and be accessible to one or more processors 16(1)-16(n) in the secure processing apparatus via a memory mapped input/output space. The reconfigurable circuit architecture 26 also can be configured to raise an interrupt request in response to an access request for the mapped memory, although the reconfigurable circuit architecture can be configured to act in other numbers and types of manners to secure processing apparatus 12.

In this example, each of the attacker computing devices 14(1)-14(n) may attempt to initiate one or more attacks or present one or more security threats to the secure processing apparatus 12, although each of the attacker computing devices 14(1)-14(n) could have other types and numbers of functions and the security threats to the secure processing apparatus 12 could come from other sources, such as from downloaded programs or applications from the Internet, emails, DVDs, CDs, or other downloaded computer readable media by way of example only. In this example, each of the attacker computing devices 14(1)-14(n) includes a central processing unit (CPU) or processor, a memory, user input device, a display, and an interface system for interacting with other devices and systems, and which are coupled together by a bus or other link to perform a variety of computing functions and operations, although each of the client computing devices 14(1)-14(n) can include other numbers and types of components, parts, devices, systems, and elements in other configurations.

Although an exemplary embodiment of the secure processing apparatus 12 is described herein, this system could also be implemented on any suitable computer system or computing device. It is to be understood that the devices and systems of the embodiments described herein are for exemplary purposes, as many variations of the specific hardware and software used to implement the embodiments are possible, as will be appreciated by those skilled in the relevant art(s).

Furthermore, each of the systems of the embodiments may be conveniently implemented using one or more general purpose computer systems, microprocessors, digital signal processors, and micro-controllers, programmed according to the teachings of the embodiments, as described and illustrated herein, and as will be appreciated by those ordinary skill in the art.

In addition, two or more computing systems or devices can be substituted for any one of the systems in any of the embodiments. Accordingly, principles and advantages of distributed processing, such as redundancy and replication also can be implemented, as desired, to increase the robustness and performance of the devices and systems of the embodiments. The embodiments may also be implemented on computer system or systems that extend across any suitable network using any suitable interface mechanisms and communications technologies, including by way of example only telecommunications in any suitable form (e.g., voice and modem), wireless communications media, wireless communications networks, cellular communications networks, 3 G communications networks, Public Switched Telephone Network (PSTNs), Packet Data Networks (PDNs), the Internet, intranets, and combinations thereof.

The embodiments may also be embodied as non-transitory computer readable medium having instructions stored thereon for one or more aspects of the present invention as described and illustrated by way of the embodiments herein, as described herein, which when executed by a processor, cause the processor to carry out the steps necessary to implement the methods of the embodiments, as described and illustrated herein.

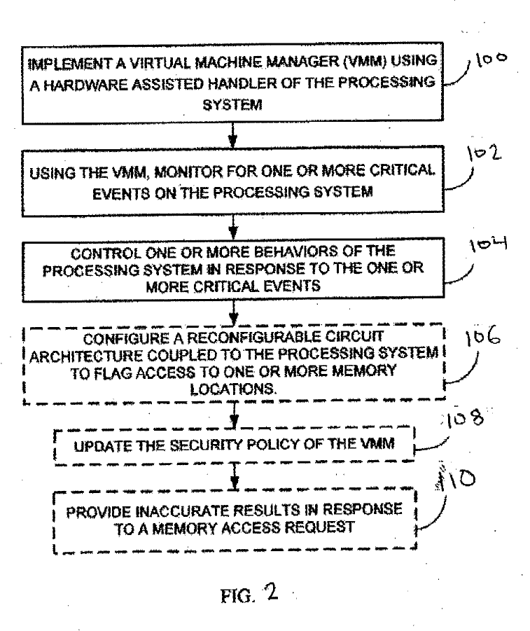

An exemplary method for securing a processing system will now be described with reference to FIGS. 1-2. The exemplary methods and devices for securing a processing system disclosed herein are capable of protecting existing modern COTS (current off-the-shelf) hardware by repurposing available features in current computer architectures, such as the x86 platform. Although the x86 platform is referred to herein for simplicity, it should be understood that the exemplary methods described herein are compatible with other types of architectures and not limited to an x86 platform.

Referring more specifically to FIG. 2, in step 100 the secure processing apparatus 12 implements an exemplary virtual machine manager (VMM) 19 using a hardware assisted handler 17. The VMM 19 may be implemented using the hardware assisted handler 17 of the secure processing apparatus 12 such that the VMM is independent of any operating system being executed in the secure processing apparatus 12. Some non-limiting examples of a suitable hardware assisted handler 17 of the secure processing apparatus 12 include a system management mode (SMM), an executive mode, or a dual monitor mode (DMM). Furthermore, in other examples, the VMM 19 may be implemented in a protected memory, such as but not limited to, SMRAM.

In step 102, using the VMM 19 one or more critical events are monitored in the secure processing apparatus 12, although other types of events and operations could be monitored. In some examples, the monitoring comprises creating a break point on the one or more critical events using a hardware virtual machine extension (VMX) of the VMM 19. As just one example, Intel-based platforms offer virtual machine extensions (VMX) as a hardware virtual machine extension of the VMM 19.

In step 104, one or more behaviors in the secure processing apparatus 12 are controlled in response to the monitoring of the one or more critical events. Depending on the embodiment, the monitoring for one or more critical events in the secure processing apparatus 12 may include auditing per core configurations and the controlling the one or more behaviors in the secure processing apparatus 12 in response to the one or more critical events may include synchronizing the per core configurations. In other embodiments, the controlling one or more behaviors in the secure processing apparatus 12 in response to the one or more critical events may include freezing operation of one or more of the multiple processor cores.

In step 106, optionally in some examples of this technology an optional reconfigurable circuit architecture 26 in the secure processing apparatus 12 may be reconfigured to flag access to one or more locations in memory 18. In examples that utilize the reconfigurable circuit architecture 26, the reconfigurable circuit architecture 26 may be configured to: 1) act as a memory of the secure processing apparatus 12 and be accessible via a memory mapped input/output space; and 2) raise an interrupt request in response to an access request for the mapped memory. In such embodiments, the one or more critical events being monitored in step 102 may include the interrupt request in response to the access request for mapped memory. Likewise in such embodiments, the action to control one or more behaviors in step 104 in response to the one or more critical events may include deciding with the VMM 19 whether or not to allow the access request for the mapped memory in response to the interrupt request. Some embodiments may include a security policy which is used to decide whether or not to allow the access request for the mapped memory.

In step 108, a security policy of the VMM 19 in the secure processing apparatus 12 may optionally be updated.

In step 110, other examples of the secure processing apparatus 12 may optionally be configured to provide inaccurate results in response to a memory access request. For example, controlling one or more behaviors in step 104 in response to the one or more monitored critical events in step 102 may include using the VMM 19 to supply an inaccurate result in response to the access request for the mapped memory in response to the interrupt request.

Accordingly, as illustrated and described with the examples above, this technology provides more effective methods and devices for securing a processing system. With this technology, unauthorized access and control to a processing system is prevented. Additionally, with this technology the processing system is not being susceptible to current modes of attack and can easily be updated for effectiveness against newly developing malware and intrusion threats. Further, with this technology existing motherboards and/or processors do not need to be replaced. Other exemplary variations of the method and device for securing a processing system as well as additional exemplary advantages of this technology will now be described below.

The hardware virtual machine extensions, such as Virtual Machine Extensions (VMX) described in the exemplary method above, provide a mechanism to isolate the operating system from hardware to allow more than one operating system to execute on the same hardware at the same time. For simplicity, the following examples will be discussed with respect to VMX, although it should be understood that other hardware virtual machine extensions could be used in other embodiments. This exemplary technology uses VMX to isolate ring 0 from the rest of the system. This isolation allows this technology to monitor the use of ring 0. Thus, even if an attacker at one of the attacker computing devices 14(1)-14(n) gains access to ring 0, their actions are still being monitored and may be prevented. In other words, VMX allows this technology to run in a hypothetical privilege mode called Ring −1.

Dual Monitor Mode (DMM) provides the x86 system with the ability to install a virtual machine monitor in System Management Mode (SMM). More specifically, DMM allows software to control the transfer from protected mode to SMM. In some embodiments, this technology utilizes DMM to protect SMM. With DMM, this technology is able to apply the same defensive technologies protecting Ring 0 in SMM. Thus, if an attacker at one of the attacker computing devices 14(1)-14(n) gains control of SMM, the attacker is isolated from the hardware allowing this technology to monitor its actions as well as prevent possible malicious activity.

By utilizing VMX and DMM in some embodiments, this technology is not only capable of protecting the secure processing apparatus 12 from existing malicious software, but also is capable of preventing entire classes of malicious software from executing. For example, one Q35 exploit remaps memory by reconfiguring the Q35 chipset. Intel's solution to this problem was to fix BIOS by locking down the remap registers. Although this is a good solution, Intel has yet to distribute new hardware with the patch. The delay allows attackers ample time to take control of the vulnerable systems. The attack also requires systems to perform a BIOS update which requires a restart of every system with the vulnerability. By contrast, this technology demonstrates a solution to the Q35 chipset by simply not allowing Ring 0 to change the configuration of the Q35 remap registers. This technology provides a software based solution that can be automatically delivered to a computing device to generate a secure processing apparatus 12 (via for example Ethernet or USB) enabling live patching of the computing device thus quickly protecting vulnerable systems without the need for a restart. Furthermore, because such an embodiment of this technology is protecting the resource and not looking for a signature, any form of malware attempting to use the Q35 vulnerability will be prevented and not just an already discovered piece of malware.

The Q35 vulnerability is one of many things this technology is capable of protecting the processing system from. MIT in 2007 released a paper showing how the Read Timestamp Counter (RDTSC) instruction can be used on a Multi-threaded system to crack AES encryption schemes. This technology is capable of controlling the RDTSC instruction down to the cycle. With this level of control, this technology can quickly and easily add enough noise to the RDTSC instruction to prevent the AES crack from succeeding.

Cache attacks may also be protected with this technology. What is needed to fix this problem is control of ring 0 to prevent malware from modifying the MSR that controls the cache policies. This technology provides this level of control of ring 0 as VMX allows for trapping on MSR reads and writes. Such an attack can be prevented utilizing this technology.

In general, this technology has the ability to prevent a variety of privileged actions on the system. This technology has many abilities, including, but not limited to the ability to prevent ring 0 software from accessing Port I/O, Memory Mapped I/O, MSRs, and Control Registers. This control can be employed by any software policy one can imagine and code up. For example, all access to a specific port can be blocked, or access can be blocked only when a certain value is being written to the port. This gives this technology a very configurable, fine-grained level of control over critical architectural components. As described in the following section, this control can be used to prevent various classes of malicious software.

As described above, this technology can mitigate a variety of privileged actions on a system, including memory access, I/O (including Port I/O & Memory Mapped I/O), and MSR access. This technology has the ability to allow or deny these actions to any ring 0 software (including the kernel and all drivers) on a case-by-case basis. This ability allows the system to fundamentally change the rules of the architecture in order to mitigate various malicious software methods. While the x86 architecture allows any software with ring 0 privileges to perform any of these actions at any time, this technology can enforce rules to prevent such access therefore changing the security model of the architecture.

This technology also provides an immediately deployable solution to mitigate the security vulnerabilities faced by multi-core x86 processors. The approach makes use of low-level software to directly manage and control the hardware. This allows this technology to benefit from both the enhanced security afforded by hardware-based approaches as well as the flexibility inherent in software-based approaches. This technology can be integrated into current information systems without the production and marketing delays faced by hardware oriented solutions that require custom fabrication and can be tailored for a specific system or be updated as needed. While this technology has been discussed with respect to x86-based multi-core processors, it may be designed in a modular fashion that will allow it to be ported and extended to additional (e.g. Cell) and future multi-core architectures and to take advantage of new architectural features when they become available.

Embodiments of this technology can utilize both Virtual Machine Extensions (VMX) and System Management Mode (SMM) features of x86 processors to provide a powerful defensive platform capable of enforcing security policies on the system, even when an attacker has gained ring 0 access. By implementing a Virtual Machine Monitor (VMM) in SMM, this technology obtains the OS independence inherent in SMM with the ability to breakpoint on critical events provided by VMX. Embodiments of this technology may also take advantage of the highest level of memory protection available in the system, namely that offered by the SMRAM locking mechanism. This will prevent an attacker from modifying the VMM, even if he knows where it resides and has full ring 0 access to the system. Additionally, by residing in SMM, this technology will have the ability to take control of all cores of the system at any time. This allows for applications such as cryptographic algorithms to operate in a single-core environment during sensitive calculations in order to prevent theft of the cryptographic key. For example, the operation of one or more of the multiple processor cores may be frozen to allow sensitive processing to occur in a single core environment. It also allows this technology to audit the configuration of each core and verify consistency among values between the cores. Although there are many cases in the x86 specification that require per-core configurations to be synchronized, a synchronization mechanism is not provided or enforced by hardware and the responsibility to comply with these requirements is left to software. Some embodiments of this technology will be able to audit such configurations on a per-core basis and be able to enforce these restrictions to keep the system in a coherent, consistent state.

To provide memory protection from DMA access, some examples of this technology may use a Field Programmable Gate Array (FPGA) as a reconfigurable circuit architecture 26 which is inserted in an available PCI slot in the secure processing apparatus 12, although other configurations and other types interfaces could be used, such as a USB port by way of example only. An FPGA is different than other hardware in that the circuitry is fully customizable via a software interface. The FPGA can be programmed to act as RAM and be accessible via Memory Mapped I/O space. This allows it to be treated as RAM by the software. However, unlike traditional RAM, the FPGA can be programmed with logic that decides if and when to grant access to a particular memory range. By having the FPGA raise an IRQ (and hence an interrupt) on accesses, for example, the system can trap to our SMM VMM to decide whether the access should be permitted. This allows some embodiments of this technology to block ring 0 or DMA access to particular memory ranges, based on a security policy. One of the CPUs 16(1)-16(n) can be configured to map sensitive tables, such as the Interrupt Descriptor Table (IDT), to this protected memory range to prevent unauthorized modifications and thus enhancing security. Furthermore, the VMM 19 can ensure that the mappings of these tables (on a per-core basis) are not changed by unauthorized software.

The combination of FPGA protected memory 26 and a VMM 19 in SMM provides a very powerful and flexible foundation that can be used to provide several important functions that are not generally available. These functions include the ability to audit ring 0 operations, to reliably report on the per-core state of the system, and to enforce security policies that restrict access to sensitive operations. As pointed out, this technology can be implemented in an OS independent fashion, relying on the x86 hardware specifications rather than specific OS features. This allows this technology to be applicable and portable to a large number of information systems, including those utilizing Windows and Linux based OSs.

Defensive mechanisms, such as this technology, that directly manipulate the hardware at the lowest levels provide a significant enhancement to the existing defenses. As attacks on computer systems become more advanced, this technology is necessary to deliver next-generation defensive solutions that allow for safe and trusted processing of information.

Examples of the Flexibility in Adapting this Technology to New Threats:

This technology can be used to create rules to prevent various classes of malicious software methods. It is helpful to consider each class independently in order to create a set of rules that is sufficient to guard the possible attack paths. Crafting these rules for each class is a multi-step process. An example of such a multi-step process includes: (1) Formally describe a minimal set of necessary actions software must take to be considered part of the given class; (2) Decompose this high level description into specific architectural level events; and (3) Use the architectural level events to craft a rule for this technology that denies the necessary actions.

In order to describe this exemplary process, consider the example of “BIOS modification and exploitation”. The first step is to formally describe this class of malicious software. The goal is to develop a description of the minimal set of actions that software needs to take to be categorized within the given class. In this example, software in the class of “BIOS modifications and exploitation” requires the ability to write to the BIOS chip. While there will be variations between specific examples from this class, they all must meet this requirement at a minimum. Furthermore, if we can provably prevent this action from occurring, then we can provably prevent this class of software.

Once we have a high level definition of requirements for the class, we can break it down into specific architectural actions. In the case, we need to examine the architectural requirements for writing to the BIOS. For Intel-based chipsets, there are a set of chipset registers, accessed via Port I/O, that control the BIOS. For an ICH9 chipset, the main register of interest here is the BIOS_CONTROL register that contains the BIOS_Write_Enable bit (bit 0 within this register). The ICH9 specification identifies the location of this register as being in PCI Configuration Space (which is accessed via port I/O to ports 0x0CF8 and 0x0CFC), in this case at Device 31, Function 0, Offset 0xDC. Thus, the architecturally defined requirement is the ability for software to set the BIOS_Write_Enable bit in the BIOS_CONTROL register at PCI Configuration Space address: Device 31, Function 0, Offset 0xDC.

This architectural definition can then translate into a rule set for this technology. In this case, a single rule is sufficient: “Deny writes to PCI Configuration Space address Device 31, Function 0, Offset 0xDC (the BIOS_CONTROL register) that set bit 0 (the BIOS_Write_Enable bit).” This is a rule that can be enforced by the disclosed systems port I/O mitigation capabilities.

While the example given above relates specifically to the “BIOS modification and exploitation” class, this methodology will also work to address various other types of malicious software. By examining the steps needed for an attack to occur and mapping those critical steps back to architectural events, we will be able to prevent entire classes of attack.

Many of the types of malicious software rely on low-level software that directly interacts with hardware in the system. This hardware includes chipset components such as the BIOS chip (or EFI/UEFI NVRAM storage) and System Management Mode RAM, and peripheral components such as hard disks, PCI/PCIe devices, and Network Interface Cards. Software interaction with any of these components must use one of the two types of I/O provided by the architecture: port I/O or memory mapped I/O. In fact, these are the only direct methods the architecture provides to software for interacting with the hardware components other than the CPU (which also uses configuration registers such as MSRs and Control Registers). This technology is designed with this architectural restriction in mind and positions itself exactly at that interface between hardware and software in order to provide the ability to monitor and control such accesses. Embodiments of this technology which use Dual Monitor Mode even allow this technology to deny I/O access to highly-privileged System Management Mode software. It is precisely this level of control that will allow this technology to mitigate advanced access methods.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for securing a processing system, the method comprising:
implementing a virtual machine manager (VMM) using a hardware assisted handler in secure processing apparatus;
monitoring for one or more critical events with the VMM in the secure processing apparatus; and
controlling with the VMM one or more behaviors in response to the one or more monitored critical events.

2. The method as set forth in claim 1, wherein the implementing further comprises implementing the VMM independent of any operating system of the secure processing apparatus.

3. The method as set forth in claim 1, wherein the implementing further comprises implementing the VMM using the hardware assisted handler comprising one of a system management mode (SMM), an executive mode, and a dual monitor mode (DMM).

4. The method as set forth in claim 1, wherein the monitoring further comprises auditing per processor core in the secure processing apparatus and the controlling further comprises synchronizing the audited per processor core.

5. The method as set forth in claim 1, wherein the controlling one or more behaviors further comprises freezing operation of one or more processor cores in the secure processing apparatus.

6. The method as set forth in claim 1, wherein the VMM is implemented in a protected memory in the secure processing apparatus.

7. The method as set forth in claim 6, wherein the protected memory comprises SMRAM.

8. The method as set forth in claim 1, wherein the monitoring further comprises creating a break point on the one or more critical events using a hardware virtual machine extension of the VMM.

9. The method as set forth in claim 1, further comprising configuring a reconfigurable circuit architecture in the secure processing apparatus to flag access to one or more locations in memory in the secure processing apparatus.

10. The method as set forth in claim 9, wherein the reconfigurable circuit architecture comprises a field programmable gate array (FPGA).

11. The method as set forth in claim 9, wherein the reconfigurable circuit architecture is further configured to act as the memory in the secure processing apparatus and be accessible to one or more processors in the secure processing apparatus via a memory mapped input/output space and raise an interrupt request in response to an access request for the mapped memory, wherein the one or more critical events being monitored with the VMM comprises the interrupt request in response to the access request for mapped memory.

12. The method as set forth in claim 11, wherein the controlling further comprises deciding with the VMM whether or not to allow the access request for the mapped memory in response to the interrupt request.

13. The method as set forth in claim 12, wherein the VMM further comprises a security policy which is used to decide whether or not to allow the access request for the mapped memory.

14. The method as set forth in claim 13, further comprising updating the security policy of the VMM.

15. The method as set forth in claim 11, wherein the controlling further comprises using the VMM to supply an inaccurate result in response to the access request for the mapped memory in response to the interrupt request.

16. A non-transitory computer readable medium having stored thereon instructions for methods for securing a processing system comprising machine executable code which when executed by at least one processor, causes the processor to perform steps comprising:
implementing a virtual machine manager (VMM) using a hardware assisted handler;
monitoring for one or more critical events with the VMM; and
controlling with the VMM one or more behaviors in response to the one or more monitored critical events.

17. The medium as set forth in claim 16, wherein the implementing further comprises implementing the VMM independent of any operating system.

18. The medium as set forth in claim 16, wherein the implementing further comprises implementing the VMM using the hardware assisted handler comprising one of a system management mode (SMM), an executive mode, and a dual monitor mode (DMM).

19. The medium as set forth in claim 16, wherein the monitoring further comprises auditing per processor core and the controlling further comprises synchronizing the audited per processor core.

20. The medium as set forth in claim 16, wherein the controlling one or more behaviors further comprises freezing operation of one or more processor cores in the secure processing apparatus.

21. The medium as set forth in claim 16, wherein the VMM is implemented in a protected memory in the secure processing apparatus.

22. The medium as set forth in claim 21, wherein the protected memory comprises SMRAM.

23. The medium as set forth in claim 16, wherein the monitoring further comprises creating a break point on the one or more critical events using a hardware virtual machine extension of the VMM.

24. The medium as set forth in claim 16, further comprising configuring a reconfigurable circuit architecture in the secure processing apparatus to flag access to one or more locations in memory in the secure processing apparatus.

25. The medium as set forth in claim 24, wherein the reconfigurable circuit architecture comprises a field programmable gate array (FPGA).

26. The medium as set forth in claim 24, wherein the reconfigurable circuit architecture is further configured to act as the memory in the secure processing apparatus and be accessible to one or more processors in the secure processing apparatus via a memory mapped input/output space and raise an interrupt request in response to an access request for the mapped memory, wherein the one or more critical events being monitored with the VMM comprises the interrupt request in response to the access request for mapped memory.

27. The medium as set forth in claim 26, wherein the controlling further comprises deciding with the VMM whether or not to allow the access request for the mapped memory in response to the interrupt request.

28. The medium as set forth in claim 27, wherein the VMM further comprises a security policy which is used to decide whether or not to allow the access request for the mapped memory.

29. The medium as set forth in claim 28, further comprising updating the security policy of the VMM.

30. The medium as set forth in claim 26, wherein the controlling further comprises using the VMM to supply an inaccurate result in response to the access request for the mapped memory in response to the interrupt request.

31. A secure processing apparatus comprising:
one or more processors with a hardware assisted handler operable to directly control the one or more processors and a virtual machine manager (VMM) implemented using the hardware assisted handler;
a memory coupled to the one or more processors which are configured to execute programmed instructions stored in the memory comprising:
implementing a virtual machine manager (VMM) using a hardware assisted handler;
monitoring for one or more critical events with the VMM; and
controlling with the VMM one or more behaviors in response to the one or more monitored critical events.

32. The apparatus as set forth in claim 31, wherein the one or more processors is further configured to execute programmed instructions stored in the memory for the implementing further comprises implementing the VMM independent of any operating system.

33. The apparatus as set forth in claim 31, wherein the one or more processors is further configured to execute programmed instructions stored in the memory for the implementing further comprises implementing the VMM using the hardware assisted handler comprising one of a system management mode (SMM), an executive mode, and a dual monitor mode (DMM).

34. The apparatus as set forth in claim 31, wherein the one or more processors is further configured to execute programmed instructions stored in the memory wherein the monitoring further comprises auditing per processor core and the controlling further comprises synchronizing the audited per processor core.

35. The apparatus as set forth in claim 31, wherein the one or more processors is further configured to execute programmed instructions stored in the memory wherein the controlling one or more behaviors further comprises freezing operation of one or more processor cores in the secure processing apparatus.

36. The apparatus as set forth in claim 31, wherein the VMM is implemented in a protected memory in the secure processing apparatus.

37. The apparatus as set forth in claim 36, wherein the protected memory comprises SMRAM.

38. The apparatus as set forth in claim 31, wherein the one or more processors is further configured to execute programmed instructions stored in the memory wherein the monitoring further comprises creating a break point on the one or more critical events using a hardware virtual machine extension of the VMM.

39. The apparatus as set forth in claim 31, further comprising configuring a reconfigurable circuit architecture in the secure processing apparatus to flag access to one or more locations in memory in the secure processing apparatus.

40. The apparatus as set forth in claim 39, wherein the reconfigurable circuit architecture comprises a field programmable gate array (FPGA).

41. The apparatus as set forth in claim 39, wherein the reconfigurable circuit architecture is further configured to act as the memory in the secure processing apparatus and be accessible to one or more processors in the secure processing apparatus via a memory mapped input/output space and raise an interrupt request in response to an access request for the mapped memory, wherein the one or more critical events being monitored with the VMM comprises the interrupt request in response to the access request for mapped memory.

42. The apparatus as set forth in claim 41, wherein the one or more processors is further configured to execute programmed instructions stored in the memory wherein the controlling further comprises deciding with the VMM whether or not to allow the access request for the mapped memory in response to the interrupt request.

43. The apparatus as set forth in claim 42, wherein the VMM further comprises a security policy which is used to decide whether or not to allow the access request for the mapped memory.

44. The apparatus as set forth in claim 43, wherein the one or more processors is further configured to execute programmed instructions stored in the memory further comprising updating the security policy of the VMM.

45. The apparatus as set forth in claim 41, wherein the one or more processors is further configured to execute programmed instructions stored in the memory wherein the controlling further comprises using the VMM to supply an inaccurate result in response to the access request for the mapped memory in response to the interrupt request.
